(19) United States
(12) Patent Application Publication
(10) Pub. No.: US 2005/0178305 A1
(43) Pub. Date: Aug. 18, 2005

(54) Golf cart and annunciation system using the same

(75) Inventor: Takayoshi Kojima, Osaka (JP)

Correspondence Address: AKERMAN SENTERFITT, P.O. BOX 3188, WEST PALM BEACH, FL, 33402-3188, US

(73) Assignee: Yosei Kojima, Osaka (JP)

(21) Appl. No.: 11/057,023

(22) Filed: Feb. 11, 2005

(30) Foreign Application Priority Data
Feb. 12, 2004 (JP) 2004-035358
Nov. 30, 2004 (JP) 2004-345336

(51) Int. Cl. G06F 7/70; G06G 7/00; H01J 40/14; G06M 7/00; G01S 1/00; A01C 1/00; A63B 55/00

(52) U.S. Cl. 111/200; 250/221; 701/301; 701/50; 280/DIG. 5

(57) ABSTRACT

There is provided a golf cart capable of repairing surfaces of fairways not manually but automatically. The golf cart is equipped with an image-taking device 31 for taking images of surface conditions on the fairways, a container 32 for accommodating joint soil, an image processing means 41 for recognizing exposed soil surfaces on the fairways based on image information imported from the image-taking device 31, and a repairing means 44 for dropping the joint soil within the container 32 on the exposed soil surfaces recognized by the image processing means 41. Thus, as the cart is moving on the fairways, every time the image processing means 41 recognizes the exposed soil surface, the repairing means 44 drops down the joint soil within the container 32 on the exposed soil surface.

### BACKGROUND OF INVENTION

1. Field of Invention

The present invention relates to a golf cart used when moving on golf courses during a golf play on golf links and also relates to an annunciation system using the same.

2. Related Prior Arts

In the case that a divot hole made by a shot remains on a golf fairway during the play of golf, it is generally recognized as a desirable playing manner to repair the divot hole, using joint soil. In that case, a player carries such joint soil on a golf cart which the player usually uses when moving from one spot to another and the player himself drops the joint soil on the divot hole to repair it every time such divot hole is made.

During the play of golf, a golf cart is allowed to move in golf links together with players with golf bags carried thereon. When a golf cart stops near a hitting spot, players take out specific golf clubs from the insides of golf bags and hit balls with the specific golf clubs, and then players return the golf clubs into the golf bags, allowing the golf cart to move on to the next hitting spot. As players repeat these actions, players often leave behind their golf clubs. Such golf clubs left behind not only hinder the play of the next or following players, but also get their play delayed too much because they must go back a good distance to look for the missing golf clubs when they notice the golf clubs have been left behind after having played in several holes.

To address this problem, Japanese Un-Examined Patent Publication No. 2003-284798 proposes that when a golf cart carrying golf bags thereon starts from a golf clubhouse, a weight sensor detects an initial weight of the golf bags; and every time the golf cart starts from a holed out position to a tee ground of the next hole, the weight of the golf bags is detected once again to determine whether any of the golf clubs has been left behind or not.

Further, Japanese Un-Examined Patent Publication No. 2004-57663 discloses a self-propelled golf cart that detects magnetically a guiding wire embedded in the earth by a guiding sensor to move automatically on a guiding pathway. Further, this golf cart is designed to detect a certain object such as a magnet that is installed near the guiding wire to thereby detect and inform reverse movement of the cart in addition to performing control of slowdown and stoppage thereof.

There have been, however, complaints that repairing every divot hole manually using the joint soil during the play is not only a nuisance to the players but also causes them to lose concentration on the play. Besides, a manager of the golf links cannot grasp which positions of fairways have been repaired, thus making it difficult to keep the fairways in a constantly good condition.

Further, there have been other complaints such that whilst a conventional golf cart is provided with a roof for protecting against rain, sides of the cart are open to the outside air and thus a cold wind would continually blow into the moving cart when it is so cold outside such as during the winter season.

Furthermore, the prior art disclosed in the aforementioned first patent publication has a drawback that since weight of the golf bags is detected during the travel of the golf cart, it is impossible to accurately determine whether any of golf clubs are left behind or not due to the weight detection being affected by vibrations resulting from irregular fairway surfaces or engine operation.

Moreover, whilst the prior art disclosed in the above-mentioned second patent publication enables the switching to a manual steering operation of the golf cart from the automatic operation by which the golf cart is moved along the guiding wire, no reverse movement can be detected if the golf cart deviates from the guiding pathway after switching to the manual operation because a detectable area resulting from the magnet magnetism is narrow. Besides, whilst golf links are normally dotted with repairing areas or the like surrounded by fences and thus golf carts deviating from the guiding pathway are likely to go accidentally into the repairing areas. According to the conventional golf carts, however, it is impossible to provide accurate information about a variety of events or troubles that are likely to occur during the travel of the cart, except the information about the reverse movement that is limited only on the guiding pathway.

### SUMMARY OF THE INVENTION

Therefore, it is a first object of the present invention to provide a golf cart capable of repairing surfaces of fairways automatically without the need of any manual works.

A second object of the present invention is to provide a golf cart capable of grasping which positions on fairways were manually repaired.

A third object of the present invention is to provide a golf cart capable of keeping an inside of a cart body warm during the winter season or the like.

A fourth object of the present invention is to provide a golf cart capable of determining accurately whether there are any golf clubs left behind during the play of golf without being affected by vibrations during the travel of the cart.

Also, a fifth object of the present invention is to provide a annunciation system using a golf cart capable of obtaining on an as-needed basis various information on possible events or troubles that might occur during the travel of a cart.

A first aspect of the present invention is a golf cart including: an image-taking device for taking images of surface conditions on fairways; a container for accommodating joint soil; an image processing means for recognizing exposed soil surfaces on the fairways based on image information imported from the image-taking device; and a repairing means for dropping the joint soil inside the container onto the exposed soil surfaces recognized by the image processing means.

Thus, every time the image processing means recognizes the exposed soil surface during the travel of the cart on the fairways, the repairing means drops the joint soil accommodated in the container onto the exposed soil surface. Consequently, players no longer need to take the trouble to drop the joint soil manually to cover the exposed soil surface, but they have only to allow the golf calf cart to travel thereon to thereby automatically repair the fairways.

A second aspect of the present invention is a golf cart further including a position detecting means for detecting a position of the cart, and a repaired position specifying means for specifying, from a detection output of the position detecting means, the positions where the repairing means dropped the joint soil.

Thus, the repaired positions where the repairing means dropped the joint soil are specified from the detection output of the position detecting means. Consequently, every time the repairing means performs repairing, the positions thus repaired are, for example, transmitted by air to a center device administrated by a manager of golf links or the repaired positions are stored in a storage medium provided in the golf cart so as to bring the data thus stored into the center device after playing golf, whereby how the fairways are repaired as a whole can be grasped in an integrated fashion.

A third aspect of the present invention is a golf cart further including a heating device for heating an inside of a cart body.

Thus, as the heating device heats the inside of the cart body, the inside of the cart body can be kept warm even during the winter season or the like.

A fourth aspect of the present invention is a golf cart further including a side enclosure in a cart body.

Thus, since no wind is allowed to blow into an inside of the cart body from the sides thereof during the travel of the cart, the inside of the cart body can be kept even warmer in cooperation with the heating by the heating device.

A fifth aspect of the present invention is a golf cart further including a warming device for warming free service articles such as beverages and golf balls.

Thus, even while players are moving on, using the golf cart, free service articles such as hot coffee, tea or beverages and warmed golf balls can be provided to players.

A sixth aspect of the present invention is a golf cart further including a housing portion for housing golf clubs separately, optical sensors each provided corresponding to the respective housing portions, a storage means for storing the initial number of the golf clubs at the start of playing golf by means of the optical sensors, and a control means for comparing the number of the golf clubs that have been read by the optical sensors during the play of golf, with the initial number stored in the storage means to output the comparison result.

Thus, every time the golf cart starts, e.g., from a holed out position to a tee ground of the next hole during the play of golf, the control means reads the number of the golf clubs carried on the golf cart by means of the optical sensors to thereby compare the number read with the initial number of the golf clubs at the start of playing golf stored in the storage means beforehand and outputs the comparison result so as to inform the comparison result through voices, display or the like. Both the initial number of the golf clubs carried on the golf cart and the number of the golf clubs during the play of golf are read by the optical sensors, so that vibrations during the travel of the cart will not affect the reading of the number of the golf clubs. Consequently, the golf clubs left behind can be precisely checked based on an output from the control means without being affected by vibrations during the travel of the golf cart.

A seventh aspect of the present invention is a golf cart further including a start switch provided so as to be operated at the start of playing golf while the aforesaid control means receives an operating signal from the start switch to read the initial number of the golf clubs based on a detection output of the optical sensors, storing the initial number of the golf clubs in the storage means.

Thus, only by operation of the start switch at the start of play, the initial number of the golf clubs can be read. Consequently, a complicated control algorithm for recognizing the initial number of the golf clubs need not be incorporated in the control means.

An eighth aspect of the present invention is a golf cart further including car speed sensors provided so as to detect stop and start of the cart such that when the car speed sensors detect the stop of the cart, the aforesaid control means starts measuring stop duration, whilst when the car speed sensors detect the start of the cart and the stop duration exceeds a predetermined period of time at that time, the control means reads a detection output from the optical sensors to calculate the number of the golf clubs while playing golf.

Thus, only when the stop duration of the cart exceeds the predetermined period of time, the control means reads the number of the golf clubs so that it is possible to determine correctly whether the golf club is left behind or not. Consequently, every time a temporary stop occurs during the movement, wasteful judgment of whether any of the golf clubs are left behind or not can be avoided.

A ninth aspect of the present invention is a golf cart in which an ultraviolet ray irradiator is provided in a cart body.

Thus, since ultraviolet rays are applied to players in the cart body, the players are sunburned.

A tenth aspect of the present invention is a annunciation system using the same comprising the aforementioned golf cart and a plurality of infrared ray emitting devices that are installed within a range of movement of the cart and emit infrared ray signals each containing unique identification data, while the cart is equipped with an infrared ray detecting means for receiving infrared ray signals from the infrared ray emitting devices and an annunciation process means for obtaining unique identification data by an detection output from the infrared ray detecting means to output announcing information corresponding to the identification data.

Accordingly, when receiving the infrared ray signals from the infrared ray emitting devices during the movement, the annunciation process means analyzes the unique identification data contained in the infrared ray signals to output the announcing information in the form of, e.g., voices and images depending on the identification data. Thus, players can obtain a variety of detailed information about the events or accidents that might occur during the travel of the cart at any time. Further, since a detectable area of the infrared ray signal is wider than that of magnetism, even if being distant from the infrared emitting device to some extent, the cart can receive necessary infrared ray signals to be able to output the announcing information.

An eleventh aspect of the present invention is a annunciation system using the same in which a plurality of infrared ray emitting devices are provided so that they are spacedly provided at spots that need annunciation within the range of movement of the cart.

Thus, when the cart approaches one of the infrared ray emitting device, the announcing information for alerting players, for example, is outputted and then when the cart approaches the next infrared ray emitting device located closer to a spot that needs annunciation for precaution, another announcing information for prohibiting the cart from entering into the spot is outputted. Consequently, a variety of the announcing information can be provided to players, depending on distances between the spot that needs annunciation for precaution and the golf cart.

A twelfth aspect of the present invention is a annunciation system using the same in which an annunciation process means changes announcing information corresponding to the identification data obtained this time depending on identification data obtained previous time.

Thus, if a source of the infrared ray signal corresponding to the identification data obtained previous time is more distant from a spot that needs annunciation for precaution when approaching than that of the infrared ray signal corresponding to those obtained this time, the announcing information may be outputted for example to inform players that the cart is approaching gradually the spot that needs annunciation for precaution. On the other hand, if the source of the infrared ray signal corresponding to the identification data obtained previous time is closer to the spot that needs annunciation for precaution when approaching than that of the infrared ray signal corresponding to those obtained this time, the announcing information may be outputted for example to inform players that the cart is getting away from the spot that needs annunciation for precaution. Consequently, by comparing the identification data obtained this time and those obtained previous time, a moving direction of the cart is determined with reference to the spot that needs annunciation for precaution when approaching, thus allowing the proper announcing information to be provided to players.

A thirteenth aspect of the present invention is a annunciation system using the same in which there is provided solar batteries serving as electric power supply to the infrared ray emitting devices.

Thus, since the electric power can be supplied to the infrared ray emitting device utilizing solar rays, troublesome maintenance such as battery exchange or the like can be limited to requisite minimum.

### BRIEF DESCRIPTION OF THE DRAWING

The invention will be more readily understood by reference to the following description, taken with the accompanying drawings, in which:

FIG. 1 is a front perspective view showing a golf cart according to one embodiment of the present invention.

FIG. 2 is a rear perspective view showing the golf cart of FIG. 1 in a full-open state.

FIG. 3 is a front view of an instrumental panel inside the cart body of the golf cart of FIG. 1.

FIG. 4 is a bottom perspective view of main portions of the cart of FIG. 1.

FIG. 5 is a block diagram explaining a functional architecture of a control box of the golf cart of FIG. 1.

FIG. 6 is a flow chart explaining operation procedures in the golf cart of FIG. 1.

FIG. 7 is a cross-sectional view of main portions of a golf club case in the golf cart of FIG. 1.

FIG. 8 is a diagrammatic illustration of a annunciation system using the same in the golf cart of FIG. 1.

FIG. 9 is a waveform diagram of infrared ray signals in the annunciation system using the same of FIG. 8.

FIG. 10 is an explanatory diagram showing a processing table incorporated in a cart annunciation process means of the annunciation system using the same of FIG. 8.

### DETAILED DESCRIPTION OF PREFERRED EMBODIMENTS

Hereunder is a description of one preferred embodiment of a golf cart according to the present invention with reference to the accompanying drawings.

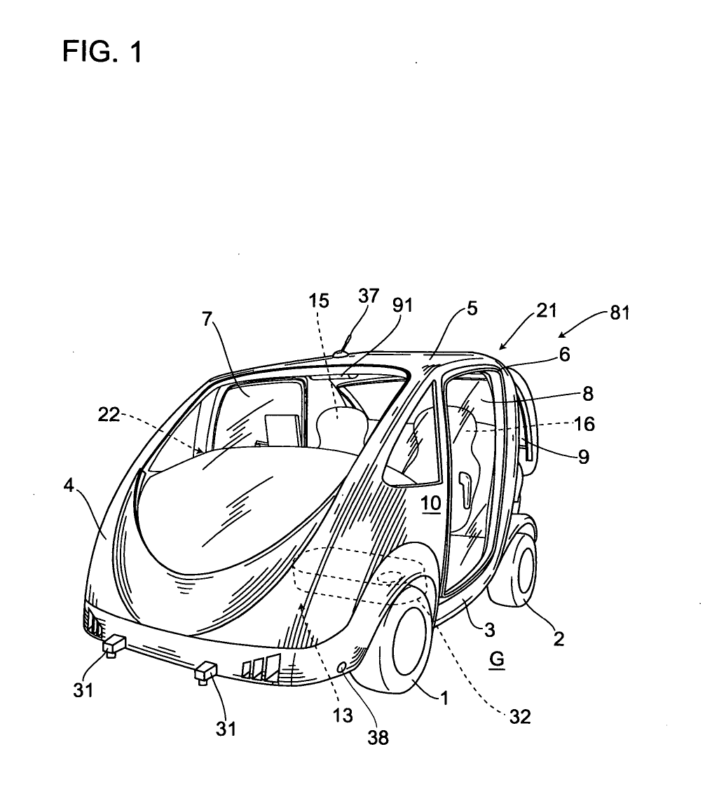

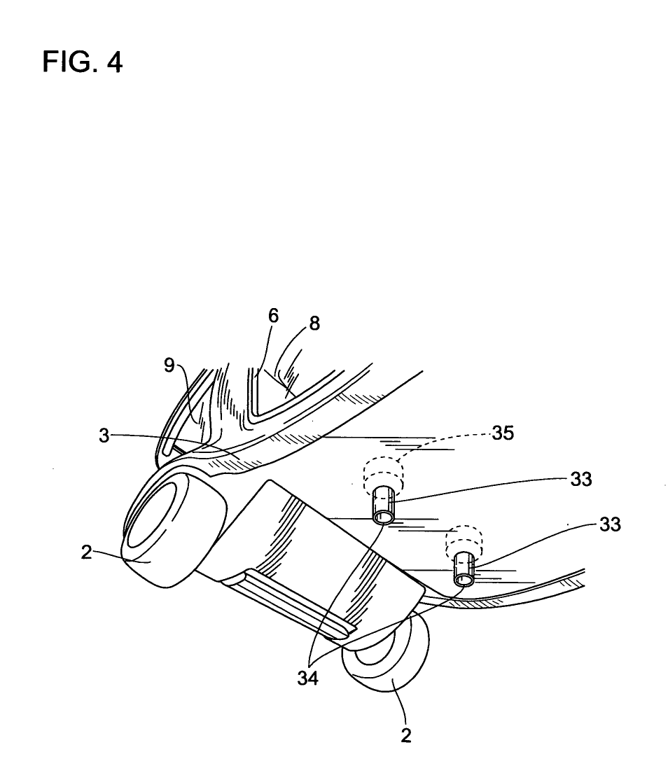

First, an external construction of the golf cart (i.e., a cart 81) is described with reference to FIGS.1 to 4. A cart body 21 constituting an outer hull of the golf cart comprises: an underbody 3 supported by front wheels 1 and rear wheels 2; a front cover 4 provided on an upper portion at a front side of the underbody 3; a main cover 5 that is provided at a rear side of the front cover 4 and forms a ceiling plane of the cart body 21, both sides of the rear side thereof as well as a rear face thereof; and a couple of doors 6 for covering both open sides of the cart body 21 in an openable and closeable manner. Numerals 7, 8, and 9 denote front glass, side glass and rear glass that are composed of transparent material, respectively.

In this embodiment, the doors 6 are provided in a stepwise slidable manner along the sides of the cart body 21. The doors 6, however, may be provided in such a manner that the doors can freely turn around its one side edge serving as the turning center. Anyway, the sides of the cart body 21 including the backside thereof may be formed with the enclosure 10 for blocking off airflow into the cart body 21 as do the main cover 5 and the doors 6.

On the underbody 3, a couple of right-and-left seats 15, 16 are provided, respectively. Opposite to the seats 15, a well-known steering wheel 17 is provided at one side of an instrument panel 22. Within the cart body 21, or to be more precise, within the instrumental panel 22, there is provided a heating device 11 for supplying warm air to an inside of the cart body 21. Regardless of whether a drive mechanism 13 is in operation or not, the heating device 11 supplies warm air, using kerosene as fuel, to the inside of the cart body 21 from outlets 23 that are provided at either both sides or a lower side of the instrumental panel 22 opposite to the seats 15, 16. While no detailed illustration is given, the cart body 21 includes a fuel supply port for heating purpose that supplies kerosene to a fuel tank provided inside the heating device 11.

Further, there are provided a cup holder 24 for holding warm beverages, for example, warmed by using hot air or hot water coming out of the heating device 11 and an openable and closeable service box 25 for putting service articles therein such as golf balls or the like with the same being kept warm. These cup holder 24 and service box 25 serving as a warming device may be provided in the instrument panel 22 or the like. The heating device 11 is constructed of a system that is separate and independent of the drive mechanism 13, such that operation of various types of operating switches 19 provided in the instrument panel 22 enables the heating device 11 to be started and stopped, and also enables airflow volume from the outlets 23 and temperatures of the hot air or hot water to be appropriately conditioned.

The drive mechanism 13 provided inside the cart main body 21 comprises: an engine for serving as a drive source; batteries for serving as an electric source; a gearbox for transmitting driving force of the engine to front wheels 1 and/or rear wheels 2; and a fuel tank for storing gasoline, for example, which serves as a fuel source of the drive mechanism 13 (neither is shown). Then, when an ignition key (not shown) is inserted into a key insertion hole to be turned, the engine in the drive mechanism 13 starts and then an accelerator pedal (not shown) may be stepped on to thereby transmit the driving force of the engine to the front wheels 1 and /or the rear wheels 2 via the gearbox, so that the cart 81 starts to move. During the movement of the cart 81, the cart is operated by turning a steering wheel 17. On the other hand, in order to stop the cart 81, a break pedal (not shown) is stepped on, while in order to stop the engine, the ignition key is turned in the reverse direction to that at the start of the engine and then the key may be taken out of the key insertion hole.

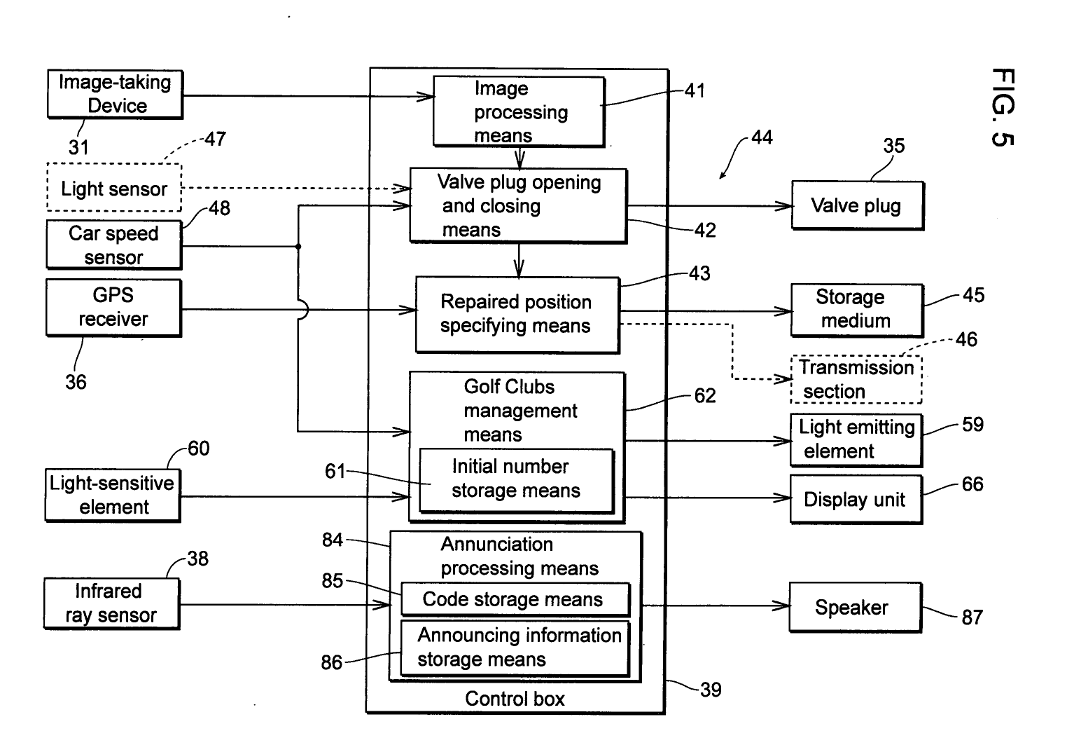

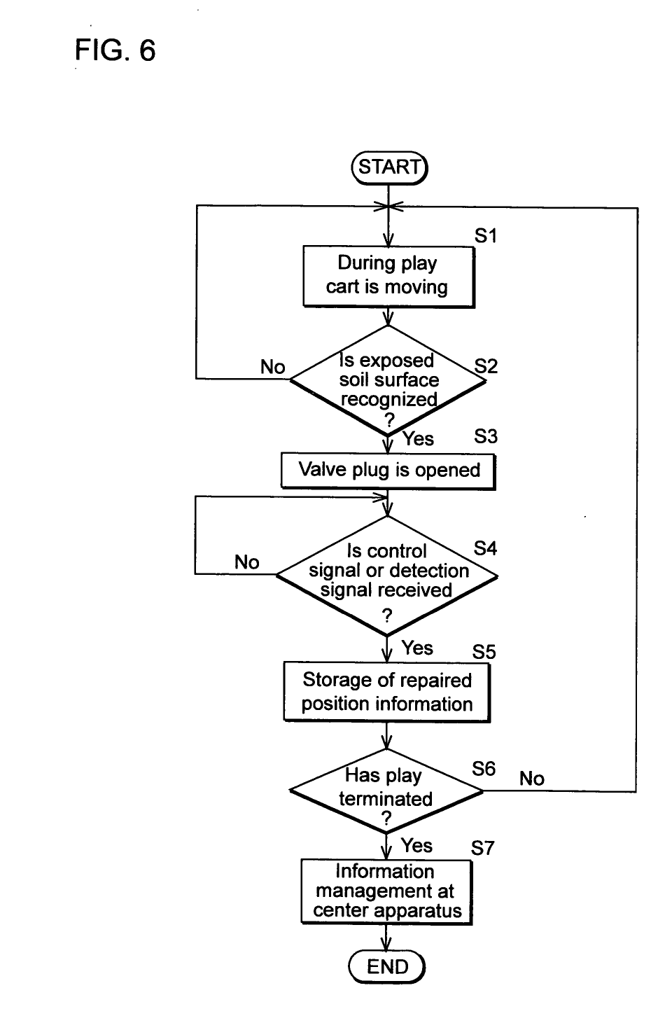

Numeral 31 denotes an image-taking device comprising a small-sized camera for taking images of surface conditions on fairways on which the cart main body 21 can move. A couple of the image-taking devices are provided on the right and the left, facing the ground G at the bottom side of an anterior portion of the underbody 3. Further, behind the image-taking devices 31, there are provided a couple of right-and-left lower end openings 34 of exhaust paths 33 that are connected to the bottom face of a container 32 that is a sand tank. When valve plugs 35 provided in a middle portion of the exhaust paths 33 are opened, joint soil that is contained in the container 32 and is used for repairing the fairways is dropped down from the lower end openings 34 of the exhaust paths 33 to the ground G. On the other hand, numeral 36 (see FIG. 5) denotes a GPS (Global Positioning System) receiver serving as a position detecting means for detecting a position of the cart main body 21, specifically the position of the image-taking devices 31, while numeral 37 denotes a receiving antenna of the GPS receiver 36. The GPS receiver 36, as is generally known, receives time signal waves that are transmitted at a predetermined frequency from artificial satellites to measure the present position of its own. Thus, it is desirable that the GPS receiver 36 be installed as near to the image-taking devices 31 as possible. The detection output obtained by the GPS receiver 36, i.e., position data are sent to a hereinafter-mentioned control box 39 in real time.

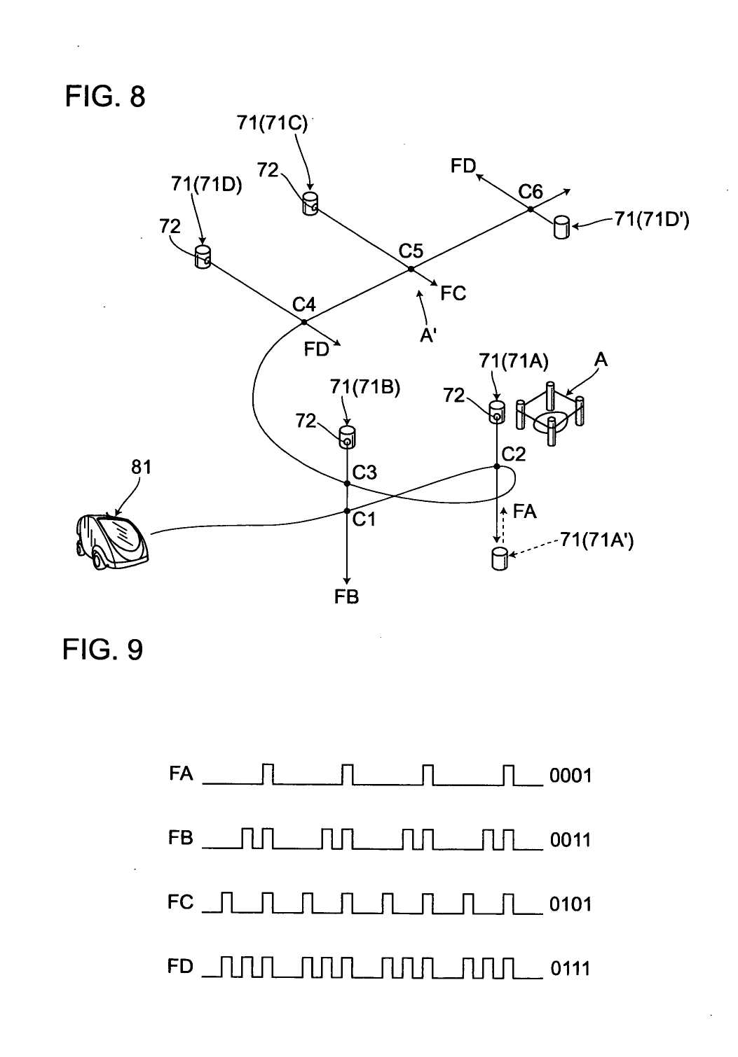

Numeral 91 denotes an ultraviolet ray irradiator mounted for example on an upper portion of the cart main body 21. The ultraviolet ray irradiator has functionality of irradiating players with ultraviolet rays who are sitting on the seats 15, 16 for a given length of time to sunburn the players. In order not to irradiate an excessive amount of the ultraviolet rays, the ultraviolet ray irradiator 91 may include a timer which stops automatically the irradiation after the given length of time has elapsed and/or a filter to moderate the intensity of the ultraviolet rays Numeral 38 denotes infrared ray sensors for serving as an infrared ray detecting means that are mounted, for example, on right and left positions of the cart body 21. The infrared ray sensor 38 picks up infrared ray signals emitted from the infrared ray emitting devices 71 (see FIG. 8) that are installed at a plurality of places in golf links. Detection outputs obtained by the infrared ray sensors 38 are also transmitted to the control box 39 in real time.

The configuration of the infrared ray emitting devices 71 is described with reference to FIG. 8. Symbols A, A′ denote spots which are located in appropriate locations in the golf links within a range of movement of the cart 81 and which needs to be given annunciation when approaching the same. They are locations into which the cart 81 must not enter such as repairing areas surrounded with fences (under repair), bankers, ponds or trees, slopes or sharp curve spots located in the middle of the course of the cart 81, transition points to the next holes, and so on. The infrared ray emitting devices 71 are each installed in proximity to each of the A, A′ spots. It is desirable that a plurality of the infrared ray emitting devices 71 are spaced in proximity to each of the A, A′ spots at intervals of several meters to several tens of meters, for example. As shown in FIG. 8, in the present embodiment, two of the infrared ray emitting devices 71A, 71B are installed at the spot A, while two of the infrared ray emitting devices 71C, 71D at the spot A′.

Each of the infrared ray emitting devices 71A, 71B that target the common spot A are equipped with infrared ray emitting elements 72 for emitting the infrared signals FA, FB in an approximately same direction. Similarly, the infrared ray emitting devices 71A, 71B that target the common spot A′ are also equipped with the infrared ray emitting elements 72 for emitting the infrared signals FC, FD in the approximately same direction. In FIG. 8, arrows indicate an emitting direction of each of the infrared ray signals FA to FD, and zones up to pointed tips of the arrows show receivable ranges of the infrared ray sensors 38.

The infrared signals FA to FD outputted from each of the infrared emitting devices 71A to 71D each contain individually different identification data. Specifically, as shown in FIG. 9, the infrared signals FA to FD are subjected to pulse code modulation using pulse trains formed by combining one or more on pulses. Here, as the identification information of each of the infrared signals FA to FD, the infrared signals FA, FB, FC, and FD contain the on pulse codes expressed as binary numbers, 0001,0011, 0101 and 0111, respectively. As a matter of course, different codes may be used and any suitable different modulation methods may be employed.

The infrared emitting devices 71A to 71D are installed in a pole-like manner protruding from the ground surface so as to be easily repaired and maintained. Alternatively, the infrared emitting devices 71A to 71D may be installed on fences placed in golf links. As shown by dotted lines in FIG. 8, a plurality of the infrared emitting devices 71A, 71A′ that emit an identical infrared ray signal FA may be arranged at mutually opposed positions. Thus, even when either of the right and left infrared ray sensors 38 of the cart body 21 cannot receive the infrared ray signal FA for some reason, the other infrared ray sensor 38 can receive the infrared signal FA, which can apply similarly to the other infrared emitting devices 71B to 71D.

Further, infrared ray emitting devices 71D, 71D′ that emit the same infrared ray signal FD may be arranged at entrances and exits of the slopes and sharp curve spots (see FIG. 8).

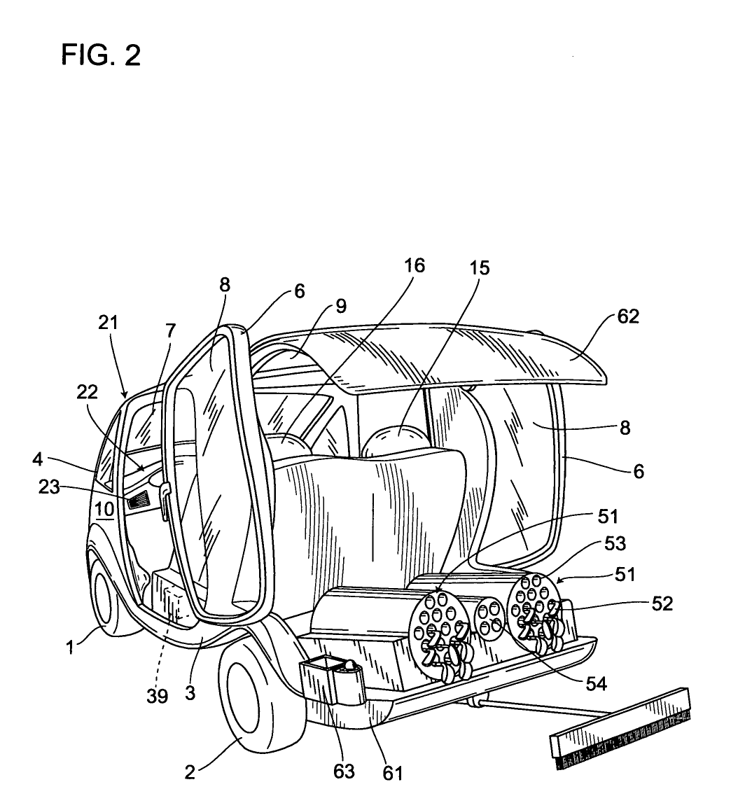

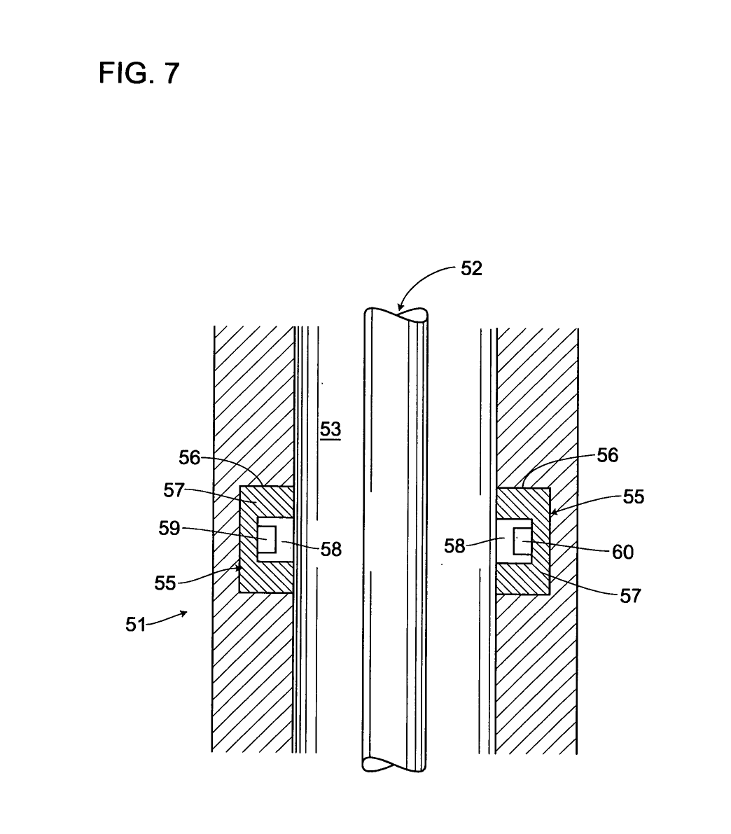

Numeral 51 denotes golf club cases provided at a rear side of the cart body 21. As shown in FIGS. 2, 7, the golf club cases 51 are provided with cylindrical holder sections 53 for housing and holding respective golf clubs 52 belonging to respective players in a manner that the respective players can freely take in and out the respective golf clubs. Since these holder sections 53 house the golf clubs 52 one by one, it is desirable that there be provided a larger number of the holder sections 53 than the number of the golf clubs 52 owned by the respective players. Therefore, in the present embodiment, there is provided a spare golf club case 54 equipped with four holder sections 53. Further, in the golf club cases 51, 54, there are provided sensor units 55 for detecting presence or absence of the golf clubs 52 in the respective holder sections 53. The respective sensor units 55 comprise either of light emitting elements 59 and light-sensitive elements 60 that are mounted on respective recesses 58 of the sensor unit main bodies 57 that are provided detachably in the recesses 56 positioned at sides of the golf club cases 51, 54. Then, when respective sensor units 55 are mounted on the recesses 56 of the golf club cases 51, 54, the light emitting elements 59 and the light-sensitive elements 60 are arranged opposite to one another at inside surfaces of the respective holder sections 53 at positions into which shafts of the golf clubs 52 penetrate. Thus, with the golf clubs 52 housed within the holder sections 53, a large proportion of light emitted from the light emitting elements 59 is shut out not to reach almost light-sensitive element 60, whereas in the absence of the golf club in the holder sections 53, the light emitted from the light emitting elements 59 is uninterrupted to reach directly the light-sensitive elements 60.

In addition, in this embodiment, the golf clubs 52 which the players mount on the cart body 21 are separately housed within the holder sections 53 for serving as housing portions. Another structure may, however, be adopted if it can realize the same functionality.

The golf club cases 51, 54 are mounted on a rear lower panel 61 mounted on a posterior portion of the underbody 3 in a rotatable manner, while a rear upper panel 62 that holds the rear glass 9 is mounted on an upper portion of the rear lower panel 61 in a rotatable manner. These rear lower panel 61 and rear upper panel 62 can be opened and shut in a hatchback manner. In addition, Numeral 63 denotes a washer that is arranged at a backside of a mud shield of the rear wheel 2 and is on the rear lower panel 61. The washer can wash any of iron golf clubs and balls.

Numeral 39 denotes a control box that controls opening and shutting of the valve plug 35 based on image information imported from the image-taking device 31 and specifies, from position data obtained by the GPS receiver 36, a position on the fairway where the joint soil within the container 32 has been dropped down and then reads the detection output from the light-sensitive elements 60 to determine whether any of golf clubs 52 are left behind or not during the play of golf.

Then, functionality of the control box 39 is described based on FIG. 5. As software functionality, the control box 39 is equipped with an image processing means 41, a valve plug opening and shutting control means 42, a repaired position specifying means 43, and a golf club management means 62. The image processing means 41 recognizes the exposed soil surfaces on the fairways on which the cart body 21 moves based on the image information imported from the image-taking device 31 and on moving speed information on the cart 81 that is detected by a car speed sensor 48. The valve plug opening and shutting control means 42 opens the valve plug 35 so as to drop the joint soil within the container 32 on the exposed soil surfaces, when the image-taking device 41 recognizes exposed soil surfaces. The repaired position specifying means 43 imports position data, when the valve plug is open, from the GPS receiver 36 as repaired position information where the joint soil has been dropped. The golf club management means 62 stores the initial number of the golf clubs 52 that have been housed within the holder section 53 of the golf club cases 51, 54, in the initial number storing means 61 by means of the detection output from the light-sensitive elements 60. Thereafter, the golf club management means 62 compares the number of golf clubs 52 that have been read from the light-sensitive elements 60 during the play of golf, with the initial number of the golf clubs 52 that has been stored beforehand in the initial number storing means 61, to output the comparison result on a display unit 66. The valve plug opening and shutting control means 42 and the valve plug 35 constitute the repairing means 44 that drops down the joint soil within the container 32 on the exposed soil surfaces recognized by the image processing means 41. Other means, however, than the valve plug 35 may be employed as a means for dropping the joint soil at the predetermined timing.

The repaired position specifying means 43 may store all the repaired position information that has been imported for example in the storage medium 45 such as an IC card, while, in some situations, there may be provided a transmission section 46 for transmitting all the repaired position information by air to a center device (not shown) installed within a golf clubhouse. Further, when control signals indicating that the valve plug 35 has been opened is outputted from the valve plug opening and shutting control means 42, the repaired position specifying means 43 specifies the position data from the GPS receiver 36 as the repaired position information. In case that no joint soil is actually dropped down due to the fact that the joint soil is absent within the container 32 or the valve fails to operate properly from any cause, a light sensor 47 serving as a joint soil drop detector, for example, may be arranged adjacently to the lower end opening 34 of the exhaust path 33, such that the light sensor 47 may detect the interruption of light outputted from a light-emitting portion to a light-receiving portion of the light sensor 47 due to actual drop of the joint soil, and according to the interruption thus detected, the repaired position specifying means 43 may import the position data from the GPS receiver 36 as the repaired position information. Thus, the repaired position information can be certainly specified by detecting that the joint soil has been actually dropped down.

The control box 39 is, besides the aforementioned means, equipped with an annunciation process means 84 for obtaining, by the detection output from the infrared ray sensors 38, unique identification information, i.e., codes contained in the infrared ray signals FA to FD to output announcing information corresponding to the codes. The annunciation process means 84 is equipped with a code storage means 85 for serving as an identification information storage means that stores the codes obtained by the detection output from the infrared ray sensors 38 previous time. Further, the annunciation process means 84 incorporates an announcing information storage means 86 for storing the announcing information comprising, for example, voice and image data of the MPEG format while associating the codes (present codes) obtained this time by the detection output from the infrared ray sensors 38 with the codes (previous codes) obtained previous time. If the present codes obtained by the detection output from the infrared ray sensors 38 are different from the previous codes stored in the code storage means 85, the voice data correspondingly associated with the present and previous codes are obtained from the announcing information storage means 86 and then the voice and image data are sent to an output means such as a speaker 87 and a display unit 66, while the present codes are overwritten on the code storage means 85 to be updated. Thus way, the announcing information processing means 84 is constructed.

In addition, the announcing information stored in the announcing information storage means 86 may be either voice data or the image data. Further, as an electric source for feeding electric power to each of the infrared ray emitting devices 71A to 71D, a primary battery, a secondary battery, and a solar battery are considered. Here, the solar battery is desirable due to little or no need for replacement and to excellent maintainability.

Next is a description of behavior of the aforementioned system. At the step S1, the joint soil is contained within the container 32 beforehand and then the players start playing golf using and moving the golf cart according to the present embodiment within a golf course. At this time, the image processing means 41 in the control box 39 is monitoring whether the exposed soil surfaces exist within the image information imported from the image-taking device 31 or not. Specifically, in this monitoring, judgments are made by recognizing a difference in color between the fairway and the exposed soil surface (step S2). At this step S2, when the image processing means 41 has recognized the presence of the exposed soil surface, the valve plug opening and shutting means 42 calculates an opening timing for opening the valve plug 35, an opening degree and opening duration of the valve plug 35 based on a size (an area) of the exposed soil surface known from the image information and on a cart 81 moving speed read from a cart speed sensor 48 (step S3). In this case, the slower the cart 81 moving speed, the later the timing for opening the valve 35. Otherwise, the valve plug 35 will be opened to drop the joint soil on the fairway before the lower end opening 34 of the exhaust path 33 reaches the exposed soil surface. Further, as for the opening degree of the valve plug 35, the larger the area of the exposed soil surface recognized by the image information, the larger the opening degree of the valve plug 35. Otherwise, an amount of the joint soil appropriate to the area of the exposed soil surface will not be dropped down.

When the valve plug 35 is opened according to the timing, the opening degree and the opening duration that has been calculated by the valve plug opening and shutting means 42, the valve plug opening and shutting means 42 transmits the control signals indicating that the valve plug 35 has opened to the repaired position specifying means 43. Otherwise, the light sensor 47 detects that the joint soil has been actually dropped down from the lower end opening 34 of the exhaust path 33 to transmit the detection signals to the repaired position specifying means 43. At the step S4, when receiving these control signals or the detection signals, the repaired position specifying means 43 imports the position data from the GPS receiver 36 at the time the valve plug 35 is open as information on the repaired position where the join soil has been dropped down, and then stores the information in the storage medium 45 (step S5). Then, at the next step S6, the sequence of the abovementioned steps S1 to S5 are repeated till playing golf comes to an end.

At the step S6, when the play of golf ends, an ending button (not shown) of the control box 39 is pushed to thereby draw the storage medium 45 from the control box 39 and then the storage medium 45 is handed to the center device. Otherwise, when the ending button of the control box 39 is pushed, all the repaired position information stored in the storage medium 45 is transmitted to the center device by air (step S7). Thus, a status of repair in the whole of the fairways can be grasped in an integrated fashion at the center device.

In the present embodiment, the heating device 11 is started by operating an operation switch 19 to be able to warm the inside of the cart body 12 by warm air out of the outlets 23 irrespective of the movement of the cart 81 by the drive mechanism 13. Consequently, the players and a crew that are inside the cart body 21 can be kept warm even in the winter season or the like. Further, in an active state of the heating device 11, the cup holder 24 and the inside of the service box 25 can also be warmed by warm air or warm water that is fed from the heating device 11. Consequently, if the beverages are housed in the cup holder 24 in advance, warm beverages can be provided to the players inside the cart body 21. Furthermore, since a space for housing golf balls is provided within the service box 25, the playing golf using warm golf balls is possible, so that players' dissatisfaction in the winter season can be swept out.

Further, an operating sequence in the abovementioned golf club management means 62 is described. When the players house one by one the golf clubs 52 they need in the holder sections 53 of the golf club cases 51, 54 provided in the cart body 21 of the golf cart, in the holder sections 53 within which the golf clubs 52 have been housed, light emitted from the light-emitting elements 59 provided in the holder sections 53 is almost interrupted by the golf clubs 52. Therefore, detection output levels of the light-sensitive elements 60 that are located opposite to the light-emitting elements 59 are lowered, whereas in the holder sections 53 in which no golf club 52 is housed, the light emitted from the light-emitting elements 59 reaches the opposite light-sensitive elements 60 without interruption, so that the detection output levels of the light-sensitive elements 60 are heightened.

Next, after checking that the cart 81 has started from the clubhouse that is predetermined position before playing golf, when a start switch not shown is operated, the golf club management means 62 that has received operation signals from the start switch reads the initial number of the golf clubs 52 housed within the golf club cases 51, 54 based on the detection outputs of the light-sensitive elements 60. At this time, the golf club management means 62 stores the number of the light-sensitive elements 60 whose detection output levels have been lowered in the initial number storing means 61 as the initial number of the golf clubs 52 before playing golf. In addition, the initial number is stored and kept as it is in the initial number storing means 61 without being renewed unless re-operating the start switch.

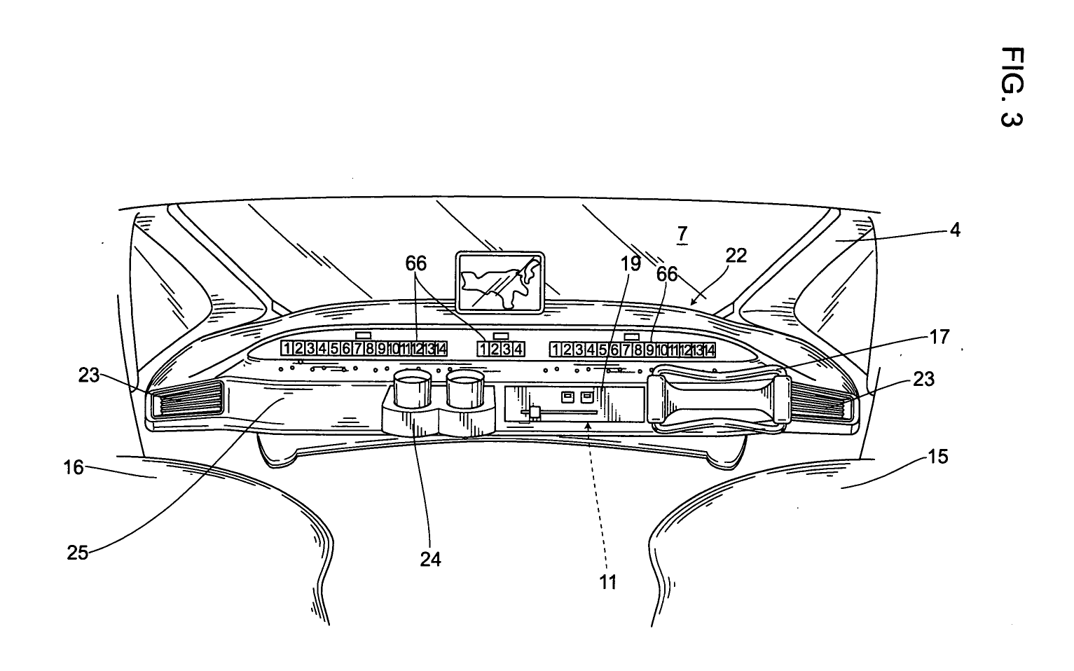

Afterward, the golf cart is moved along the predetermined course from the clubhouse and every time the player intends to make a shot, the player stops the cart 81 to get out of the cart body 21 and then the player draws a necessary golf club 52 from the golf club cases 51, 54 to use it. After making a shot, the player gets in the cart body 21 again to move the cart 81 to the next hitting point. At this time, the golf club management means 62 detects, by means of the car speed sensor 48, that the cart 81 has stopped to measure the stop duration by a built-in counter means (not shown). Then, when the car speed sensor 48 detects that the cart 81 has started again and if the stop duration exceeds a predetermined time, the golf club management means 62 determines that the stop duration is not intended to stop temporarily but intended to stop the cart 81 to make a shot. Therefore, the golf club management means 62 reads the detection output of each light-sensitive element 60 to calculate the number of the golf clubs that are housed within the golf club cases 51, 54 during the present golf play, while the golf club management means 62 compares the number of the golf clubs 52 that have been read from the light-sensitive elements 60 this time with the initial number of the golf clubs 52 that had been stored beforehand in the initial number storing means 61 before playing golf. If it is detected that the number of this time is decreased from the initial number, that effect is displayed on the display unit 66. In this case, the display unit 66 in the present embodiment can display not only a golf club 52 left behind but also the present number of the golf clubs 52. In addition, the display unit 66 shown in FIG. 3 comprises a plurality of light-emitting diodes and displays the number of the golf clubs 52 housed within the golf club cases 51, 54.

Further, at every hole, there are provided a cart pass detecting sensor for detecting that the cart 81 moves to the next place and thereby when the cart 81 passes above the cart pass detecting sensor, a hole play termination notifying signal is transmitted from the transmission section 46 to the center device. The center device unifies the management of play-on-hole termination notifying signals from each cart 81. Furthermore, a system may be incorporated that distributes position information showing the present positions of the carts 81 and position information on the anterior and posterior carts respectively to a receiving section (not shown) of each cart 81. In this case, a judgment section not shown that is provided in the center device or in each cart 81 calculates a distance between the anterior and posterior carts 81 based on the position information. When the distance between these carts 81 is far greater than the predetermined value, notification for preventing the golf play from being delayed is sent to the posterior cart 81, e.g., by the display unit 66. The notification is given so that a displaying form on the display unit 66 is, for example,., may be changed from attention to warning step-by-step depending on the distances between the carts 81. Besides, the notification may be given not by the display unit 66 but by a notifying means such as voices, while in this case, the urgency of the notification form of the notifying means may be heightened step-by-step depending on the distances between the carts 81. Thus, the golf club 52 left behind can be early found to be able to prevent the golf play from being delayed as much as possible. Further, in order to detect positions to which each cart 81 has moved, instead of the cart pass detecting sensor, the GPS receiver 36 may be used to transmit, by using the transmission section 46, position data obtained by the GPS receiver 36 periodically to the center device.

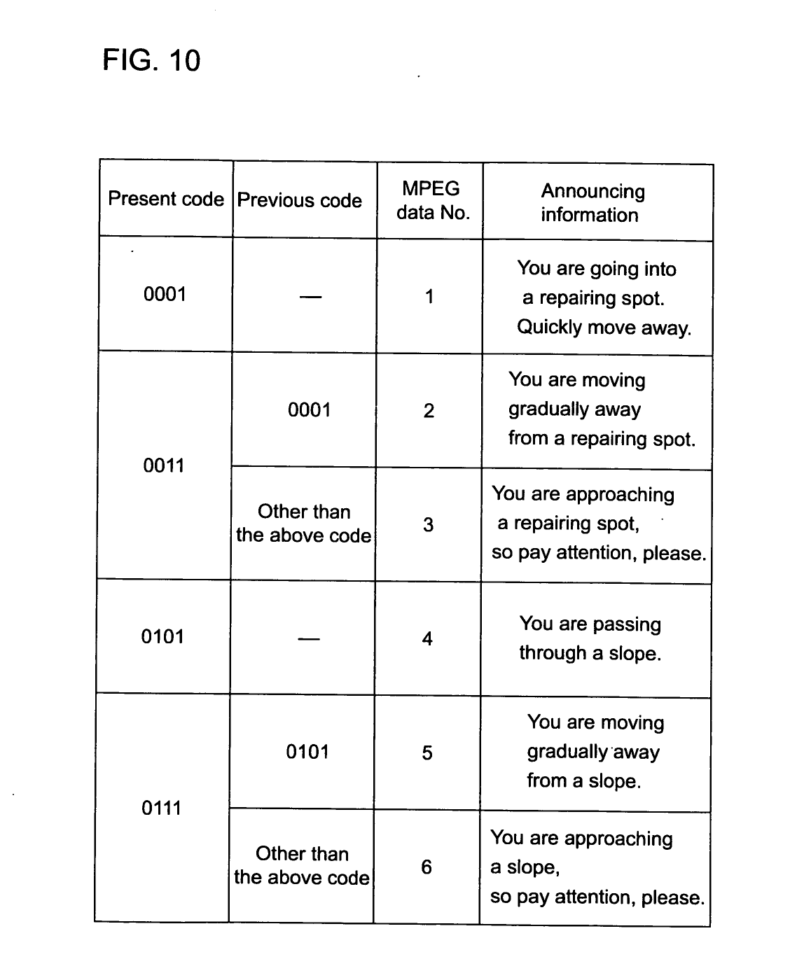

Next, performance of the cart announcing system is described which combines the infrared ray sensors 38 and the annunciation process means 84 with reference to FIG. 8 to FIG. 10. As shown in FIG. 8, it is assumed that some cart 81 passes through a moving course of a sequence of, for example,., C1→C2→C3→C4→C5→C6 within a golf links. Every time receiving the detection output from the infrared ray sensors 38 during the travel of the cart 81, the annunciation process means 84 within the control box 39 makes a judgment on which annunciation be output using a processing table shown in FIG. 10 by the present codes contained in the infrared signals FA to FD, and as the case may be, by the previous codes stored in the code storage means 85. In addition, at the initial state immediately after pushing the start switch, the previous codes stored in the code storage means 85 are cleared.

Firstly, when the cart 81 passes through the course C1, the infrared sensors 38 of the cart 81 picks up the infrared ray signal FB emitted from the infrared emitting device 71B. The annunciation process means 84 receives the diction output from the infrared sensors 38 to decode the present codes contained in the infrared ray signal FB. Here, the present code is 0011. Since the previous code stored in the code storage means 85 has been cleared, it can be understood that at least the cart 81 is moving to a repairing spot that is a spot A. Consequently, the annunciation process means 84 reads out announcing information of data number 3 from the announcing information storage means 86 according to the processing table in FIG. 10 to output the announcing information to the display unit 66 and the speaker 87. Thus, from the speaker 87, e.g., “You are approaching a repairing spot, so pay attention, please” is announced. Further, the annunciation process means 84 stores the present code 0011 in the code storage means 85.

Regardless of the announcement of the attention described above, if the cart 81 approaches further the repairing spot that is the spot A, when the cart 81 has passed through the course C1, then the infrared ray sensors 38 picks up the infrared ray signal FA emitted from another infrared ray emitting device 71A. When decoding that the present code contained in the infrared ray signal FA is 0001, from the announcing information storage means 86, the annunciation process means 84 reads out immediately the announcing information of data number 1 based on the table shown in FIG. 10 without reading out the previous code 0011 stored in the code storage means 85 and then outputs the announcing information to the display 66 unit and the speaker 87. Thus, from the speaker 87, e.g., “You are going into a repairing spot. Quick move away, please.” is announced.

That is, as being installed nearby the spot A, the infrared ray emitting device 71A outputs the announcing information for moving the cart 81 away from the spot A regardless of the meaning of the previous code 0011 when having picked up the infrared ray signal FA of the code 0001. Then, the annunciation process means 84 stores the present code 0001 in the code storage means 85.

When the cart 81 moves away gradually from the repairing spot A and passes through the course C3, the infrared ray sensors 38 of the cart 81 comes to pick up again the infrared ray signal FB emitted from the infrared ray emitting device 71B. When decoding that the present code contained in the infrared ray signal FB is 0011, based on the table shown in FIG. 10, the annunciation process means 84 reads out the previous code 0001 stored in the code storage means 85 and further reads out the announcing information of data number 2 associated with the present code 0011 and the previous code 0001 from the announcing information storage means 86 and then outputs the announcing information to the display unit 66 and the speaker 87. As a result, from the speaker 87, for example, “You are moving away gradually from a repairing spot” is announced. On the other hand, the annunciation process 84 stores the present code 0011 in the code storage means 85.

In this way, when the infrared ray sensors 38 picks up the infrared ray signal FB of the infrared ray emitting device 71B located somewhat apart from the spot A, the annunciation process means 84 reads out digits of the code of the infrared ray signal that has been previously picked up. If the previous code is proved to be contained in the infrared ray signal FA of another infrared ray emitting device 71A located nearer to the spot A, the cart 81 is determined to be moving away from the repairing spot, whereas if the previous code is proved to be contained in the infrared ray signals FC, FD of the infrared ray emitting device 71C, 71D located more away from the spot A, the cart 81 is determined to be moving nearer to the repairing spot. Then, according to the judgment, different announcing information is outputted to the display unit 66 and the speaker 87 and therefore players can gain an reliable understanding of whether the cart is moving nearer to the spot A or not.

Thereafter, when the cart 81 approaches a slope at a spot A′ and passes through the moving course C4, the infrared ray sensors 38 picks up the infrared ray signal FD emitted from the infrared ray emitting device 71D. Then, when decoding that the present code contained in the infrared signal FD is 0111, the annunciation process means 84 reads out the previous code 0011 stored in the code storage means 85 based on the table shown in FIG. 10 and further reads out the announcing information of data number 6 associated with the present code 0111 and the previous code 0011 and then outputs the announcing information to the display unit 66 and the speaker 87. As a result, from the speaker 87 “You are approaching a slop, so pay attention, please” is announced. At the same time, the annunciation process means 84 stores the present code 0111 in the code storage means 85.

If the cart 81 approaches further the slope at the spot A′ regardless of the aforementioned announcement, when the cart 81 has passed through the moving course C5, the infrared ray sensors 38 picks up the infrared ray signal FC emitted from another infrared ray emitting device 71C. When decoding that the present code contained in the infrared ray signal FC is 0101, the annunciation process means 84 immediately reads out the announcing information of data number 4 based on the table shown in FIG. 10 without reading out the previous code 0111 stored in the code storage means 85 and then outputs the announcing information to the display unit 66 and the speaker 87. As a result, from the speaker 87, for example,., “You are passing through a slope. ” is announced.

That is, as being installed fairly nearby the spot A′, the infrared ray emitting device 71C outputs the announcing information for making the cart 81 get away from the spot A′ regardless of the meaning of the previous code 0111 when picking up the infrared ray signal FC of the code 0101. At the same time, the annunciation process means 84 stores the present code 0101 in the code storage means 85.

When the cart 81 moves away gradually from the slope at the spot A′ and passes through the moving course C6, the infrared ray sensors 38 of the cart 81 comes to pick up the infrared ray signal FD emitted from the infrared ray emitting device 71D. When decoding that the present code contained in the infrared ray signal FD is 0111, based on the table shown in FIG. 10, the annunciation process means 84 reads out the previous code 0101 stored in the code storage means 85 and further reads out the announcing information of a data number 5 associated with the present code 0111 and the previous code 0101 from the announcing information storage means 86 and then outputs the announcing information to the display unit 66 and the speaker 87. As a result, from the speaker 87, for example,., “You are moving away from a slope” is announced. At the same time, the annunciation process means 84 stores the present code 0111 in the code storage means 85.

By repeating these procedures, around the spot A, to each of cases of approaching the A spot, of having reached the vicinity of the spot A, and of moving away from the spot A, the announcing information appropriate to each case is outputted, respectively, while around the spot A′, to each of cases of approaching the A′ spot, of having reached the vicinity of the spot A′, and of moving away from the spot A′, the announcing information appropriate to each case is outputted, respectively. To each of cases of approaching the A′ spot, of having reached the vicinity of the spot A′, and of moving away from the spot A′, appropriate announcing information is each output. The reachable range of the infrared ray signals FA to FD is by far wider than that of the conventionally used magnetism, so that proper announcing information can be provided to the cart 81 arbitrarily moving inside the golf links.

Besides, other than the system described above, a system may be incorporated that outputs the annunciating information for informing for example,., a sharp curve spot encountered and that for informing the next hole number.

As described above, the golf cart 81 according to the present embodiment is equipped with the image-taking device 31 for taking images of the surface conditions of the fairways, the container 32 for containing the joint soil, the image processing means 41 for recognizing the exposed soil surfaces on the fairways based on the image information imported from the image-taking device 31, and the repairing means 44 for dropping the joint soil within the container 32 on the exposed soil surfaces recognized by the image processing means 41.

In this case, as the cart is moving on the fairways, every time the image processing means 41 recognizes the exposed soil surface on the fairways, the repairing means 44 drops down the joint soil contained within the container 32. Hence, only by moving the golf cart 81 so as to cover the exposed soil surfaces, the surfaces of the fairways can be automatically repaired without bothering to drop the joint soil by hand.

In the system like this, the golf cart 81 according to the present embodiment is further equipped with the GPS receiver 36 for serving as a position detecting means for detecting cart 81 positions, and the repaired position specifying means 43 for specifying, from the detection output of the GPS receiver 36, the positions where the repairing means 44 has dropped down the joint soil.

Thus, the repaired positions where the repairing means 44 has dropped down the joint soil can be specified from the detection output of the GPS receiver 36. Hence, every time the repairing means 44 performs repairing, for example,., the repaired positions are transmitted by air to the center device a golf course manager maintains or the repaired positions are stored in the storage device 45 provided in the golf cart and the storage medium 45 is taken in to the center device after playing golf, so that at the center device, the status of the repair in the whole of the fairways can be grasped in an integrated fashion.

Additionally, since the GPS receiver 36 is used for detecting a specified one point of the golf cart 81, when the lower end opening 34 of the exhaust path 33 facing the repairing position where the joint soil is dropped down and the GPS receiver 36 are distant from each other to some extent, a correcting means for correcting this distance may be provided in the repaired position specifying means 43. The distance between the GPS receiver 36 and the lower end opening 34 of the exhaust path 33 is always constant and therefore if the distance is measured in advance, only by doing addition or subtraction between the position data from the GPS 36 and the distance, the correcting means can calculate correctly the repairing position where the joint soil is dropped down.

Further, it is desirable that the heating device 11 for heating the inside of the cart body 21 be provided as is the golf cart according to the present embodiment. In this case, the heating device 11 warms the inside of the cart body 21, so that the inside of the cart body 21 can be kept warm in the winter season or the like.

In this case, further, by providing the enclosure 10 at the sides of the cart body 21, no wind blows from the sides into the inside of the cart body 21 during the movement of the cart 81 and therefore the inside of the cart body 21 can be kept warmer in cooperation with warm air effected by the heating device 11.

Furthermore, the heating device 11 may be equipped with the cup holder 24 and the service box 25 that serve as a warming device for warming service articles such as the beverages and the golf balls. Thus, even while the players are on the move by using the golf cart, the service particles such as warm beverages and warm golf balls are arbitrarily drawn from the cup holder 24 and the service box 25 to be able to provide the players with them.

Moreover, the golf cart 81 of the present embodiment includes the holder sections 53 for serving as a housing portion for housing separately the golf clubs 52, the light emitting elements 59 and the light-sensitive elements 60 that are each provided corresponding to the holder sections 53 and serve as the optical sensor, the initial number storage means 61 for serving as a storage means for storing the initial number of the golf clubs 52 at the start of playing golf by the light emitting elements 59 and the light-sensitive elements 60, and a golf club management means 62 for serving as a control means for comparing the number of the golf clubs read by the light-sensitive elements 60 during the play of golf with the initial number stored in the initial number storage means 61 to output the comparison result.

Thus, during the play of golf, every time the golf cart starts from, e.g., the holed out position to a tee ground of the next hole, the golf club management means 62 reads the number of the golf clubs 52 carried on the golf cart by the light-sensitive elements 60 and then compares the number read with the initial number of the golf clubs 52 that has been stored beforehand in the initial number storage means 61 at the start of playing golf to output the comparison result outward so as to enable notification by means of, e.g., voices and display or the like. The initial number of the golf clubs 52 carried on the golf cart 81 and the number of the golf clubs during the play of golf are both read by the light-sensitive elements 60 that constitutes the optical sensor. Hence, the numbers of the golf clubs 52 are absolutely undisturbed by vibrations during the travel of the golf cart 81. Consequently, the number of the golf clubs 52 is unsusceptible to the vibrations during the travel of the golf cart 81, so that it can be correctly determined whether any of the golf clubs 52 are left behind during the play of golf or not based on an output from the golf club management means 52.

Further, there is additionally provided the start switch (not shown) that is operated at the start of playing golf. Thus, when receiving an operating signal from the start switch, the initial number of the golf clubs 52 is reads based on the detection output of the light-sensitive elements 60 to be stored in the initial number storage means 61. Thus, the golf club management means 62 may be architected. Thus, only by operating the start switch at the start of playing golf, the initial number of the golf clubs 52 can be read. Consequently, complicated control algorithm for recognizing the initial number of the golf clubs 52 need not be incorporated in the golf club management means 62.

Furthermore, in the present embodiment, there is additionally provided a car speed sensor 48 for detecting the stop and start of the cart 81. Thus, when the cart speed sensor 48 detects the stop of the cart 81, the golf club management means 62 measures the stop duration and subsequently when the cart speed sensor 48 has detected the start of the car, if the stop duration of the cart 81 has exceeded a predetermined time, the golf club management means 62 reads the detection output from the light-sensitive elements 60 to calculate the number of the golf clubs 52 during the play of golf. Thus, only when the stop duration of the cart 81 exceeds the predetermined time, the golf club management means 62 reads the number of the golf clubs 52 by the detection output from the light-sensitive elements 60 to be able to determine correctly whether any of the golf clubs 52 are left behind or not. Consequently, it can be prevented that every time temporary stop occurs during the travel of the cart 81, whether any of the golf clubs 52 are left behind or not is determined in vain.

Moreover, there is provided the ultraviolet ray irradiator 91 in the cart body 21. Hence, the ultraviolet ray can be irradiated to the players to be able to sunburn the players.

In the cart 81, the annunciation system using the same of the present embodiment is equipped with the aforementioned golf cart 81, a plurality of the infrared ray emitting devices 71A to 71D that are arranged within the range of movement of the cart 81 and emit the infrared ray signals FA to FD each containing unique identification data (codes), the infrared ray sensors 38 for receiving the infrared ray signals from the infrared ray emitting devices 71A to 71D, and the annunciation process means 84 for obtaining the unique codes from the detection outputs from the infrared ray sensors 38 to output the announcement information corresponding to the codes.

In this case, when receiving the infrared ray signals FA to FD from the infrared ray emitting devices 71A to 71D during the movement, the announcement processing means 84 analyzes the unique codes contained in the infrared ray signals FA to FD to output the announcing information corresponding to the codes, e.g., in the form of the voices and the images. Thus, as needed, the players can obtain details of a variety of the announcement information that can be assumed during the travel of the cart 81. Besides, the infrared ray signals FA to FD have larger detectable areas than does magnetism, so that even the cart 81 that is distant from the infrared ray emitting devices 71A to 71D to some extent can receive the necessary infrared signals FA to FD to be able to output the announcement information.

Further, a plurality of the infrared ray emitting devices 71A, 71B or 71C, 71D are spaced at intervals in each of the spots A, A′ which are located within the range of movement of the cart 81 and which needs the annunciation. Hence, when the cart 81 approaches the first infrared emitting device 71B, e.g., at the A spot, e.g., the announcement information for calling attention is outputted and further when the cart 81 approaches the next infrared ray emitting device 71 A located nearer to the spot which needs the annunciation, e.g., another announcement information for instructing inhibition of entrance thereto can be output. Consequently, a variety of the announcement information can be provided to the players depending on distances between the spots A, A′ which needs the annunciation and the cart 81.

The annunciation process means 84 of the present embodiment changes the announcing information corresponding to the code obtained this time depending on the code obtained previous time.

In this case, if a source of the infrared ray signal FD corresponding to, e.g., the code 0111 obtained previous time is more distant from the spot which needs the annunciation than a source of the infrared ray signal FB corresponding to, e.g., the code 0011 obtained this time, e.g., the announcing information can be output that informs that the cart 81 is gradually approaching the spot which the announcement is needed, whereas if a source of the infrared ray signal FA corresponding to, e.g., the code 0001 obtained previous time is nearer to the spot which needs the annunciation than a source of the infrared ray signal FB corresponding to, e.g., the code 0011 obtained this time, e.g., the announcing information can be output that informs that the cart 81 is gradually getting away from the spot which needs the annunciation. Consequently, by comparing the code obtained this time and that obtained previous time to specify a moving direction of the cart 81 with the spot which needs the annunciation defined as reference, the correct announcing information can be provided to the players.

Here, it is desirable that a solar battery is provided as electric power supply to the infrared ray emitting devices 71A to 71D. In this case, electric power can be supplied to the infrared ray emitting devices 71A to 71D using the solar energy and therefore troublesome maintenance including battery exchange or the like can be limited to the minimum.

The present invention is not limited to the embodiments described above and various modifications are possible within the scope of the gist of the present invention. The golf cart 81 according to the present embodiment, e.g., is provided with an inside structure suitable for passenger use of one to multiple players. A car intended exclusively to repair the fairways, however, may be applicable and further a cart 81 may be applicable whose unmanned operation is possible by radio control from the center device.

1. A golf cart, comprising:
an image-taking device for taking images of surface conditions on fairways;
a container for accommodating joint soil;
an image processing means for recognizing exposed soil surfaces on the fairways based on image information imported from said image-taking device; and
a repairing means for dropping the joint soil accommodated in said container onto the exposed soil surfaces recognized by said image processing means.

2. The golf cart according to claim 1, further comprising:
a position detecting means for detecting cart positions; and
a repaired position specifying means for specifying repaired positions where the joint soil was dropped by said repairing means, said repaired position specifying means specifying the repaired positions from a detection output of said position detecting means.

3. The golf cart according to claim 1, further comprising a heating device for heating an inside of a main body of said golf cart.

4. The golf cart according to claim 3, wherein said main body of the golf cart comprises a side enclosure.

5. The golf cart according to claim 3, wherein said heating device includes a warming device for warming unrequited service articles such as beverages and golf balls distributed free in a golf course.

6. The golf cart according to claim 1, further comprising:
a holder with housing portions for housing golf clubs separately;
optical sensors provided in said housing portions, said optical sensors corresponding to said housing portions, respectively;
a storage means for storing the initial number of the golf clubs at the start of play by means of said optical sensors; and
a control means for comparing the number of the golf clubs read by said optical sensors during the play of golf with the initial number of the golf clubs stored in said storage means so as to output a result of comparison.

7. The golf cart according to claim 6, further comprising a start switch operated at the start of play so that said control means receives an operation signal from the start switch to read the initial number of the golf clubs based on a detection output of said optical sensors, and stores the initial number of the golf clubs in said storage means.

8. The golf cart according to claim 6, further comprising a car speed sensor for detecting stop and start of the cart so that said control means measures a duration of cart stop when said car speed sensor detects the stop, and then said control means reads a detection output from said optical sensors so as to calculate the number of the golf clubs during the play of golf if the duration of cart stop exceeds a predetermined period of time when said car speed sensor detects the start of the cart.

9. The golf cart according to claim 1, further comprising an ultraviolet ray irradiator provided in said cart body.

10. An annunciation system using a golf cart, comprising:
a golf cart of claim 1,
a plurality of infrared ray emitting devices that are installed within a range of movement of the cart, each infrared ray emitting device emitting infrared ray signals containing unique identification data, wherein
said cart comprises: an infrared ray detecting means for receiving the infrared ray signals from said infrared ray emitting devices; and an annunciation process means for obtaining said unique identification data through a detection output from the infrared ray detecting means and then outputting announcing information corresponding to the identification data.

11. The annunciation system according to claim 10, wherein a plurality of said infrared emitting devices are spacedly provided at certain spots that need annunciation within said range of movement of the cart.

12. The annunciation system according to claim 11, wherein said annunciation process means changes announcing information corresponding to identification data obtained this time depending on the identification data obtained previous time.

13. The annunciation system according to claim 10, wherein solar batteries are provided as an electric power source for supplying electric power to said infrared ray emitting devices.
